(19) United States
(12) Patent Application Publication
(10) Pub. No.: US 2010/0300107 A1
(43) Pub. Date: Dec. 2, 2010

(54) METHOD AND FLOW SLEEVE PROFILE REDUCTION TO EXTEND COMBUSTOR LINER LIFE

(75) Inventors: Jesse Ellis Barton, Simpsonville, SC (US); Jonathan Dwight Berry, Simpsonville, SC (US); James Thomas Brown, Piedmont, SC (US); Mark Allan Hadley, Greenville, SC (US); Patrick Benedict Melton, Horse Shoe, NC (US); Svetlana Yakubova, Greer, SC (US)

Correspondence Address: CANTOR COLBURN LLP, 20 Church Street, 22nd Floor, Hartford, CT, 06103, US

(73) Assignee: GENERAL ELECTRIC COMPANY, Schenectady, NY (US)

(21) Appl. No.: 12/474,371

(22) Filed: May 29, 2009

(51) Int. Cl. F02C 7/12; F23R 3/42

(52) U.S. Cl. 60/772; 60/752

(57) ABSTRACT

A gas turbine includes a combustor liner having at least one hole formed therein. The gas turbine also includes a flow sleeve that at least partially surrounds the liner thereby forming a plenum between the flow sleeve and the liner, the plenum having an airflow therethrough, a portion of the airflow passing through the at least one hole in the liner and into the liner thereby reducing the mass of the airflow in the plenum. The flow sleeve has an axial profile that is reduced in cross section dimension at a predetermined axial location of the flow sleeve, thereby reducing a width of the plenum at the predetermined axial location. The reduction at the cross section dimension in the flow sleeve increases a velocity of the airflow in the plenum at the predetermined axial location, the increased velocity airflow increasing transfer of heat away from the liner.

### BACKGROUND OF THE INVENTION

The subject matter disclosed herein relates to gas turbines and, in particular, to the profile of a flow sleeve that extends the useful life of a liner of a gas turbine combustor.

In a gas turbine that includes a diffusion type (i.e., non-premixed) combustor, relatively high head end temperatures may be experienced on the inner surface of, e.g., the film-cooled, multi-nozzle quiet combustor (“MNQC”) liner (for example, near the row #1 mixing holes). In general, the “head end” of the combustor typically refers to the portion or area of the combustor (usually at one end thereof) where the fuel and air are premixed together for subsequent combustion further along within the combustor. The relatively high head end temperatures may be increased even further when the combustor burns certain fuels, such as syn gas fuels (e.g., LHV, CO and H2 in fuel composition, flowing through primary and secondary fuel passageways). To mitigate this issue, performance and/or operability compromises may be made, such as requiring additional diluent, or reducing the combustor firing temperature, in an attempt to reduce the liner temperatures and thereby satisfy durability requirements of the combustor design.

For combustors of the Dry Low Nitrous Oxides (“Nox”-“DLN”) type, local liner thermal maximums or gradients are often caused by non-uniform flame structure. These DLN combustors often run with different fuel splits going to various nozzles, which result in non-uniform thermal loading of the liner. For certain types of DLN combustors, there is typically no available air for use in film cooling (i.e., the liner has no holes therein to pass compressed air into the liner for film cooling of the inner surface of the liner), in contrast to diffusion MNQC liners. As a result, hot side thermal barrier coatings and backside heat transfer coefficients may be utilized to attempt to enhance the ability of the DLN combustor liner to meet the desired useful life requirements of the combustor.

With respect to general combustor liner backside cooling, film cooling typically has been used on MNQC, diffusion liners, while turbulated liners have been used with the non-film cooling types of DLN combustors. Also, 2-cool designs have been implemented on liners to improve cooling in the area of the aft end hula seal.

Further, it is known to utilize a flow sleeve, which typically surrounds at least a portion of the combustor liner, thereby forming an annular passage or plenum therebetween through which cooling air, e.g., from the compressor, may flow to cool at least a portion of the liner through the outside surface of the liner. That is, the liner and flow sleeve may be arranged concentrically with respect to one another, with the liner on the inside and the flow sleeve on the outside. Flow sleeves often have several rows of cooling holes, with or without thimbles, which typically direct cooling air onto the aft end of the liner. The compressed air may also be used for mixing with the fuel from fuel nozzles in the combustor. That is, the compressed air flowing from the gas turbine compressor into a combustion zone of the combustor typically flows through the annulus or plenum between the liner and flow sleeve and also flows through holes in the liner into the combustion zone. The compressed air typically flows in one direction between the liner and flow sleeve, and reverses direction as it enters the liner, and flows as a hot gas in an opposite direction out of the liner and combustor and into the turbine portion of the gas turbine.

### BRIEF DESCRIPTION OF THE INVENTION

According to an aspect of the invention, a gas turbine includes a combustor liner having at least one hole formed therein. The gas turbine also includes a flow sleeve that at least partially surrounds the liner thereby forming a plenum between the flow sleeve and the liner, the plenum having an airflow therethrough, a portion of the airflow passing through the at least one hole in the liner and into the liner thereby reducing the mass of the airflow in the plenum. The flow sleeve has an axial profile that is reduced in cross section dimension at a predetermined axial location of the flow sleeve, thereby reducing a width of the plenum at the predetermined axial location. The reduction at the cross section dimension in the flow sleeve at the predetermined axial location of the flow sleeve increases a velocity of the airflow in the plenum at the predetermined axial location, thereby increasing transfer of heat away from the liner.

According to another aspect of the invention, a gas turbine includes a combustor liner having at least one hole formed therein, and a flow sleeve that at least partially surrounds the liner thereby forming a plenum between the flow sleeve and the liner, the plenum having an airflow therethrough, a portion of the airflow passing through the at least one hole in the liner and into the liner thereby reducing the mass of the airflow in the plenum. The gas turbine also includes a flow sleeve insert disposed next to an inner surface of the flow sleeve at a predetermined axial location of the flow sleeve, the flow sleeve insert having an axial profile that is reduced in cross section dimension at the predetermined axial location of the flow sleeve, thereby reducing a width of the plenum at the predetermined axial location. The reduction at the cross section dimension in the flow sleeve insert increases a velocity of the airflow in the plenum at the predetermined axial location, thereby increasing transfer of heat away from the liner.

According to yet another aspect of the invention, a method for cooling a combustor liner includes providing a combustor liner with at least one hole formed therein. The method also includes providing a flow sleeve that at least partially surrounds the liner thereby forming a plenum between the flow sleeve and the liner, the plenum having an airflow therethrough, a portion of the airflow passing through the at least one hole in the liner and into the liner thereby reducing the mass of the airflow in the plenum. The flow sleeve has an axial profile that is reduced in cross section dimension at a predetermined axial location of the flow sleeve, thereby reducing a width of the plenum at the predetermined axial location. The reduction at the cross section dimension in the flow sleeve increases a velocity of the airflow in the plenum at the predetermined axial location, thereby increasing transfer of heat away from the liner.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a perspective view of a flow sleeve according to an embodiment of the invention;

FIG. 2 is a cross-section view of the flow sleeve of FIG. 1;

FIG. 3 is a cross-section view of the flow sleeve of FIG. 1 in relation to a liner of a combustor according to an embodiment of the invention;

FIG. 4 is an end view of the flow sleeve of FIG. 1 and the combustor liner of FIG. 3;

FIG. 5 is a perspective view of a flow sleeve with a retrofit insert added to the flow sleeve in accordance with an another embodiment of the invention;

FIG. 6 is a cross-section view of the flow sleeve and retrofit insert of FIG. 5; and

FIG. 7 is a perspective view, partially cutaway, of the flow sleeve and retrofit insert of FIG. 5.

The detailed description explains embodiments of the invention, together with advantages and features, by way of example with reference to the drawings.

### DETAILED DESCRIPTION OF THE INVENTION

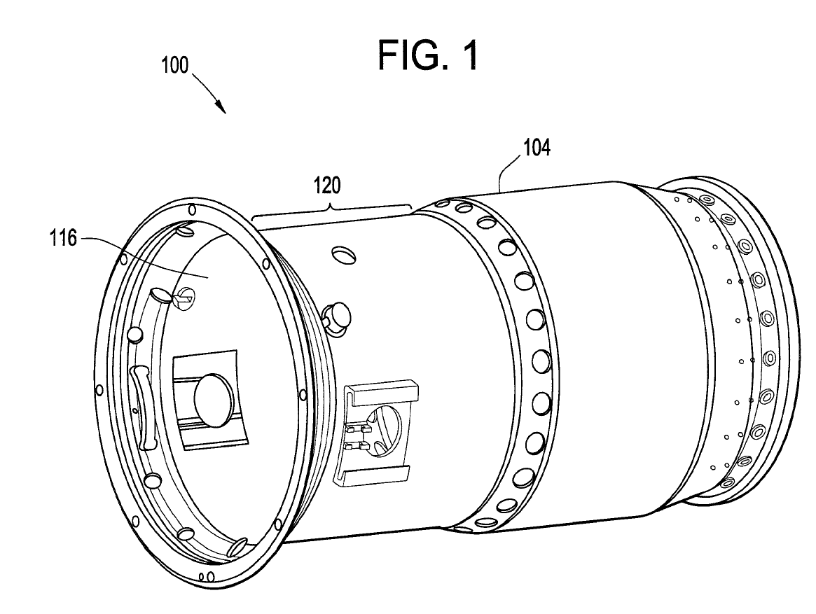

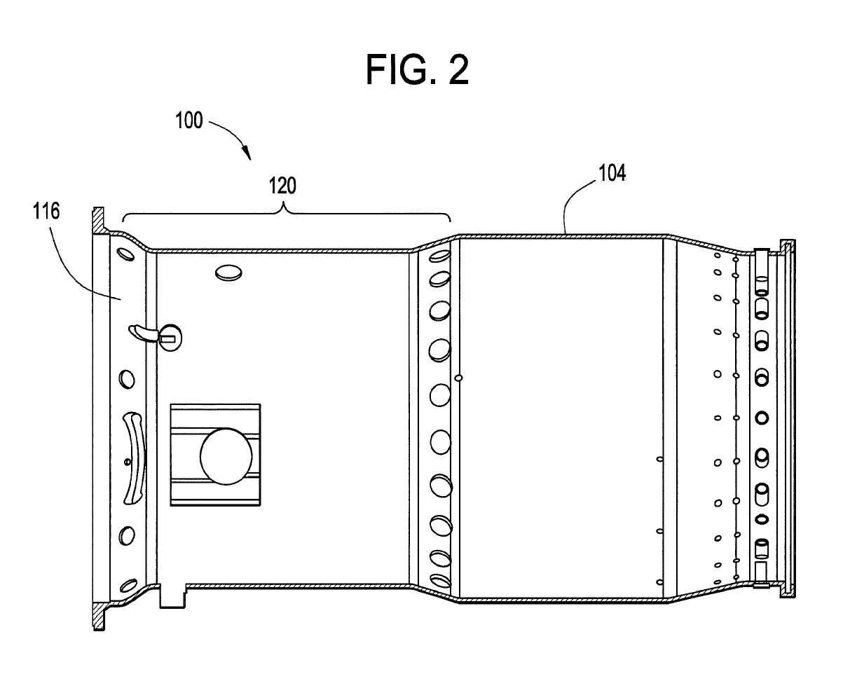

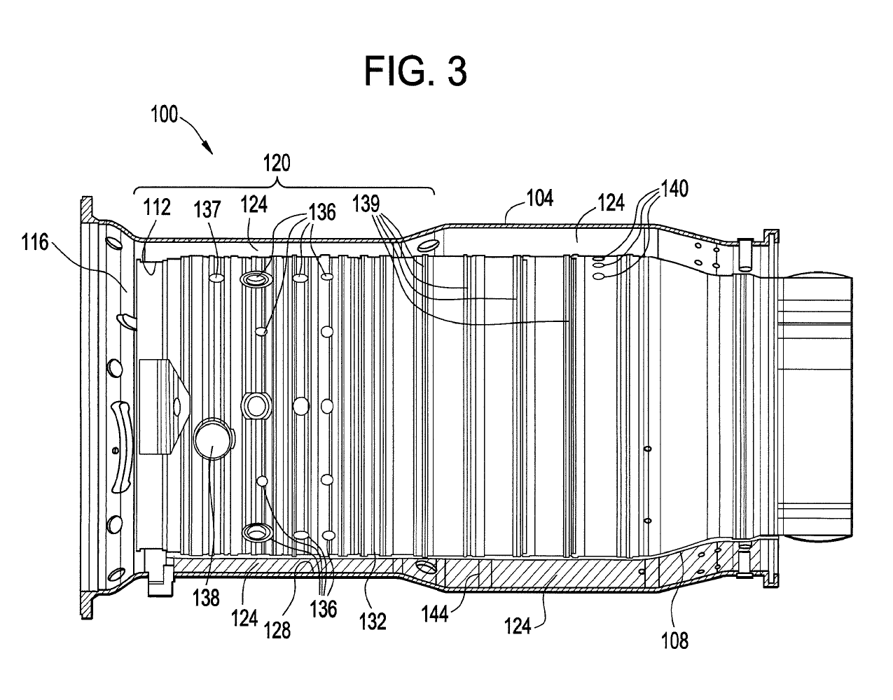

In FIGS. 1-3, a flow sleeve 100 according to an embodiment of the invention is generally circular in cross section, although other shapes are possible. The length dimension of the flow sleeve 100 in FIGS. 1-3 (i.e., left to right in FIGS. 1-3) may be considered the axial dimension of the flow sleeve 100, while the “profile” of the flow sleeve 100 may be considered the shape of the flow sleeve 100 as seen by viewing an outer surface 104 (and, thus, an inner surface) of the flow sleeve 100 taken along this axial dimension. The flow sleeve 100 may be part of a diffusion or DLN type (or other type) of combustor of a gas turbine that utilizes film cooling. As such, the flow sleeve 100 may at least partially surround or be concentric with at least a portion of a liner 108 (FIG. 3) that is also part of the combustor.

As mentioned, the liner 108 is typically exposed to relatively high temperatures resulting from combustion of the air and fuel mixture within the liner 108. Thus, an inside surface 112 of the liner 108 may be at a relatively high temperature at certain one or more locations along the liner 108. Typically these location(s) are where the flame is anchored and the inside surface 112 of the liner 108 is at the relatively hottest temperature within all of the liner (i.e., the combustion primary zone). A left end 116 of the flow sleeve 100 (as viewed in FIGS. 1-3) may be considered to be the “head end” of both the flow sleeve 100 and the liner 108. It is this head end 116 of the liner 108 where the temperature resulting from combustion of the fuel/air mixture may typically be locally the hottest with respect to the liner 108. As such, the head end 116 of the liner 108 may be the location of the liner that is life limiting for the overall liner 108.

According to an embodiment of the invention, the flow sleeve 100 has an axial profile that is reduced in its cross section dimension for at least one portion of the flow sleeve 100 at a predetermined axial location 120 of the flow sleeve 100 for a certain length thereof and with respect to the remaining portion of the flow sleeve 100. The length of this reduced cross section dimension portion 120 of the flow sleeve 100 may be sufficient to adequately cool the length of the liner 108 that is the hottest. Also, the location of this reduced cross section portion 120 may be located anywhere deemed appropriate for reducing the temperature of the liner 108—typically, at its hottest location. Further, there may be more than one reduced cross section portion 120, if desired, depending upon the temperature characteristics of the liner 108 (i.e. more than one “hot spot” location of the liner 108 to be cooled). Each reduction 120 at the cross section dimension may be uniform in dimension throughout the entire circumference of the reduction, or, in the alternative, the reduction 120 may be non-uniform in dimension circumferentially. Also, as seen in FIGS. 1-3, after the reduced cross section portion 120, the flow sleeve 100 may increase in cross section along the profile of the flow sleeve as it moves down the axial length of the flow sleeve 100.

As seen in FIG. 3, the dimensional reduction at the predetermined axial location 120 of the flow sleeve 100 decreases the amount of the clearance (or the width of the annulus or plenum) 124 between an inside surface 128 of the flow sleeve 100 and an outside surface (“cold side”) 132 of the liner 108 at this location 120 (as compared to the width of the remaining portion of the annulus or plenum 124). This “restricted” annular area 120 has the effect of increasing the velocity of the “bulk” airflow located in the annulus 124 between the flow sleeve 100 and the liner 108 at the predetermined axial location 120 of the cross section reduction of the flow sleeve 100. This increased airflow increases heat transfer away from the liner 108 (i.e., increases “backside cooling” or increases the heat transfer coefficient on the outer surface 132 or cold side 132 of the liner 108), thus providing for adequate localized cooling of the liner 108 at the relatively hottest portion thereof. This has the added benefit of increasing the durability of the liner 108. Thus, as seen from the foregoing, the use of the dimensional reduction 120 in the flow sleeve 100 allows for the axial variation of the flow sleeve cooling profile.

In a typical film cooled diffusion type combustor or a film cooled DLN type combustor, the liner 108 has a number of mixing holes 136 formed therein, as seen in FIG. 3. The mixing holes 136 can be circular or any other shape and can be located in the liner 108 at locations that are typical in the art. These mixing holes allow for a portion of the compressed airflow to pass through these holes 136 and enter the liner 108 where the compressed air is used to break up the cohesive fuel jets introduced with the fuel nozzles. The compressed airflow mixes with the fuel and is used in the combustion process of the fuel/air mixture entering the head end of the combustor via the fuel nozzles. There are also multiple rows of film cooling holes 139. These circumferential rings of holes allow for a portion of the compressed airflow to pass through these holes 139 and enter the liner 108 where the compressed air is used to film cool the inside surface 112 of the liner 108 and is also later mixed with fuel and used in the combustion process of the fuel/air mixture entering the head end of the combustor via the fuel nozzles. Additional locations of compressed air entry into the liner are the spark plug (SP)/flame detector (FD) hole(s) 137, the crossfire tube hole(s) 138, and the dilution hole(s). Thus, as the compressed airflow moves through the plenum 124 between the flow sleeve 100 and the liner 108, part of the mass of that airflow is “lost” to inside the liner 108 and, therefore, is not available for cooling of the outside surface 132 of the liner 108. As seen in FIG. 3, the mixing holes 136 are located in the restricted annular area 120 of the flow sleeve 100. This loss of the airflow to the inside of the liner 108 is typically not a linear loss, given the different features of the liner 108 (e.g., cooling holes, dilution holes, cross fire tubes, etc.). Thus, as can be seen from the foregoing, embodiments of the invention provides for an apparatus and a method for increasing the velocity of the airflow through a restricted flow area while at the same time experiencing a loss of mass of the airflow to the inside of the liner 108.

In embodiments of the invention, the axial length of the liner 108 is typically unchanged with or without the inclusion of the flow sleeve 100 with the restricted flow area 120. Further, as the airflow passes through the restricted area 120 within the plenum 124, the airflow will become relatively hotter in temperature, as the airflow will pick up additional heat from the liner 108 by way of convective heat transfer from the liner 108 and due to the increased velocity of the airflow in the restricted area 120 of the plenum 124 and the increased heat transfer coefficient resulting from the restricted area 120. This cooling effectiveness occurs even though there is occurring a loss of the mass of the airflow through the mixing holes 136 and into the liner 108. This portion of the mass airflow is relatively hotter in temperature as compared to where the airflow entered the head end of the liner 108. Then, as the relatively hotter airflow passes through the mixing holes 136 and into the liner, the relatively hotter airflow participates in the combustion process.

Also shown cross-hatched in FIG. 3 is one of several (e.g., six) guide vanes 144 that may be located in the plenum 124 between the flow sleeve 100 and the liner 108. Each guide vane 144 may have a length that spans nearly the entire length of the plenum 124. The guide vanes may be equally spaced around the circumference of the flow sleeve 100 (for example, between each fuel nozzle), thereby establishing a corresponding number of circumferential sections of the plenum 124. The guide vanes 144 may be used to address any localized thermal hotspots or gradients that may otherwise limit the useful life of the liner 108. This is achieved through the use of the guide vanes 144 channeling the airflow down the various sections of the plenum 124 effectively created by the placement of the guide vanes 144. Thus, the guide vanes 144 allow for the circumferential variation of the flow sleeve cooling profile.

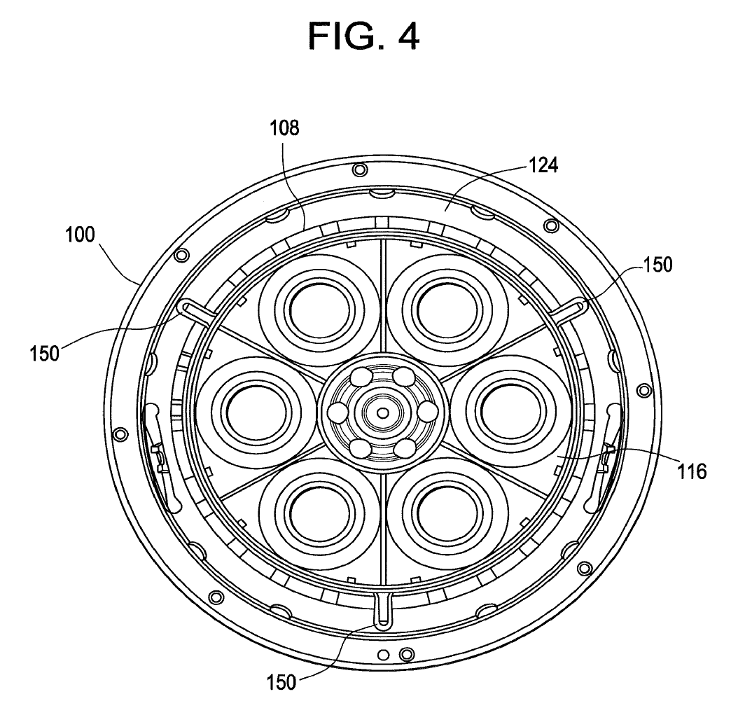

In FIG. 4 are three liner stops 150 located on the liner 108. The liner stops 150 control the radial (clocking) and axial (travel) of the liner 108 within the flow sleeve/combustor assembly

Embodiments of the flow sleeve 100 of the invention provide a solution to the relatively high temperatures typically located at the head end 116 of a film cooled, MNQC combustor liner 108. The solution is in the form of a flow sleeve 100 having one or more diametrical reductions in one or more certain areas 120 along the axial profile of the flow sleeve 100. This results in annular restrictions within the plenum or annulus 124, thereby increasing the velocity of the airflow between the combustor liner 108 and the flow sleeve 100 in these reduced diametrical or cross section areas 120. This also increases the heat transfer coefficient on the outer surface or cold side 132 of the liner 108.

The local annulus reduction increases the airflow velocity over the backside 132 of the combustor liner 108, thereby increasing the forced convection from that surface 132. This results in lower backside liner temperatures for the same operating and boundary conditions. This is of interest in diffusion combustors as they may experience relatively high temperatures in the associated film cooled, MNQC liners at any point or location where air enters and mixes with fuel; for example, the row #1 mixing holes. This is also of interest in DLN combustor liners employing film cooling where relatively high local temperatures and gradients result from the various fuel splits being run in the combustor. A local increase in the high temperature coefficients at the various point of interest may lower temperatures and smooth out thermal gradients.

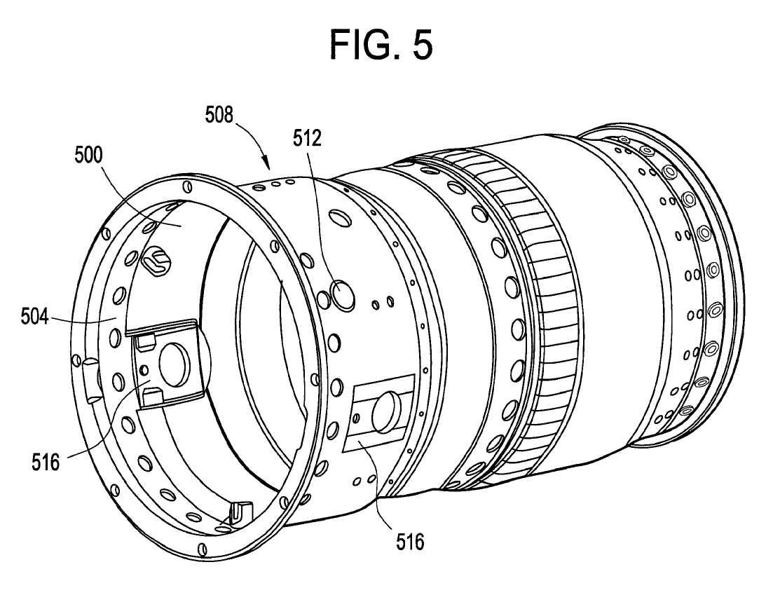

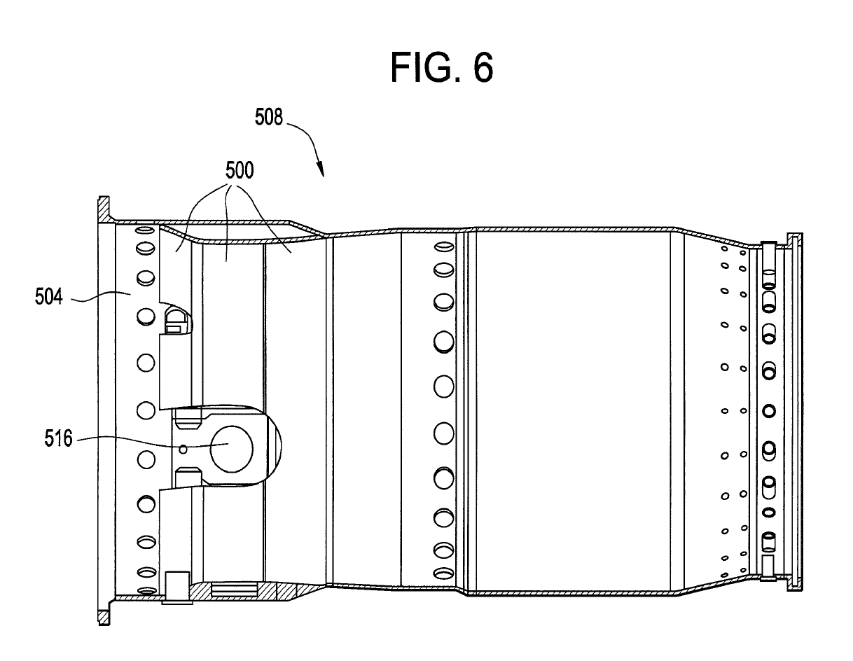

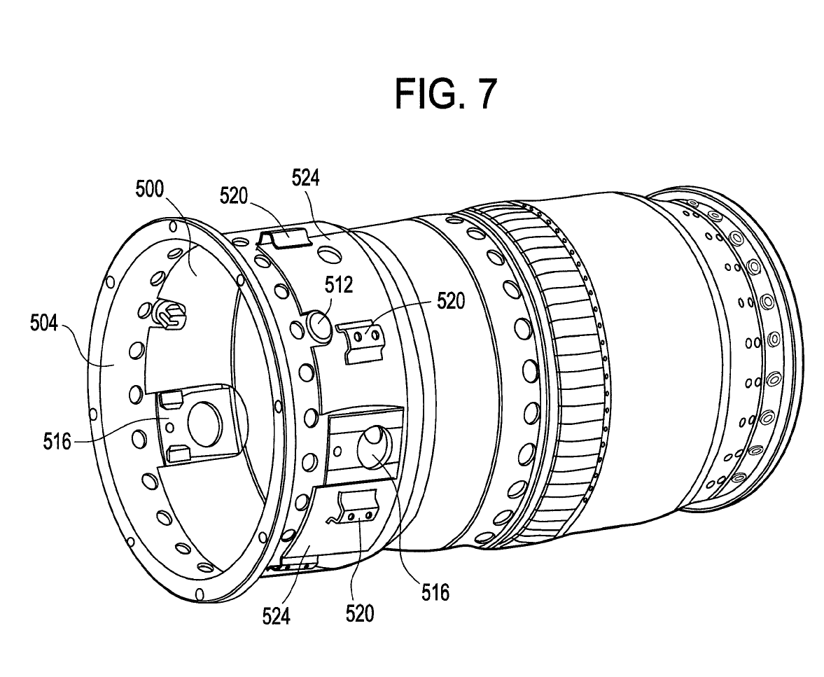

In FIGS. 5-7, a flow sleeve retrofit insert 500 is attached to the inner surface 504 of an existing flow sleeve 508 (i.e., one already in service in the field). As in the embodiment of the flow sleeve 100 of FIGS. 1-4, the use of the retrofit insert 500 has the similar effect of reducing the amount of clearance or distance (i.e., creating a “restriction”) between an inner surface 504 of the flow sleeve 508 and an outer surface of the liner, similar to the liner shown in FIG. 3, thereby increasing airflow velocity near the flow sleeve 508 at the predetermined axial location of the cross section reduction, which increases heat transfer away from the liner.

As shown, the retrofit insert 500 (which may comprise a single piece of suitable material) has several cutouts to accommodate the liner mounts 512 and the crossfire tube retainer ramps 516 that are located on the inner surface of the flow sleeve 508. Also, FIG, 7 shows one method for mounting the retrofit insert 500 to the inner surface 504 of the flow sleeve 508 using a number of spaced apart mounts 520. Each mount 520 may be welded, riveted, brazed, bolted or attached by other suitable means to both the inner surface 504 of the flow sleeve 508 and an outer surface 524 of the retrofit insert 500. Also, other devices besides mounts 520 may be utilized to attach the retrofit insert 500 to the flow sleeve 508. Adding the retrofit insert 500 to an existing flow sleeve 508 at the predetermined axial location of the flow sleeve 508 has the same effects as the embodiments of the flow sleeve 100 described hereinbefore and illustrated in FIGS. 1-4. Also, similar to the embodiment of FIGS. 1-4, the one or more reductions in the retrofit insert 500 at the cross section dimension may be uniform throughout the entire circumference of the reduction, or, in the alternative, the reduction may be non-uniform circumferentially.

Embodiments of the invention address the undesirable relatively high temperatures typically located at the head end of the combustor liner and the resulting liner durability challenges (e.g., cracking) experienced with MNQC diffusion combustors in, for example, integrated gasification combined cycle (“IGCC”) applications. Also, embodiments of the invention may be utilized in new flow sleeve designs or may be retrofitted to flow sleeve designs already in the field, for example, those with front mounted flow sleeves. In addition, embodiments of the invention may be used to address local hot spots or streaks experienced with DLN combustor liner applications (i.e., provide local liner temperature reductions, thereby improving durability of the DLN combustor liner).

For example, embodiments of the invention can achieve relatively significant temperature reductions on the liner assembly at the head end near the row #1 mixing holes. This can be achieved without undesired effects such as impact to combustor pressure drop or undesirable combustor dynamics. Also, there is no compromise to the operability or performance of the combustor and turbine in achieving the results obtained with the flow sleeve of embodiments of the invention.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A gas turbine, comprising:
a combustor liner having at least one hole formed therein; and
a flow sleeve that at least partially surrounds the liner thereby forming a plenum between the flow sleeve and the liner, the plenum having an airflow therethrough, a portion of the airflow passing through the at least one hole in the liner and into the liner thereby reducing the mass of the airflow in the plenum, the flow sleeve having an axial profile that is reduced in cross section dimension at a predetermined axial location of the flow sleeve, thereby reducing a width of the plenum at the predetermined axial location, wherein the reduction at the cross section dimension in the flow sleeve increases a velocity of the airflow in the plenum at the predetermined axial location, thereby increasing transfer of heat away from the liner.

2. The gas turbine of claim 1, the predetermined axial location of the flow sleeve comprising a relatively hot temperature location of the liner.

3. The gas turbine of claim 2, the relatively hot temperature location of the liner being located at a head end of the liner.

4. The gas turbine of claim 1, the liner comprising a liner for a diffusion combustor.

5. The gas turbine of claim 1, the liner comprising a liner for a Dry Low Nitrous Oxides combustor.

6. The gas turbine of claim 1, the reduction at the cross section dimension at the predetermined axial location of the flow sleeve being with respect to a remaining portion of the flow sleeve.

7. The gas turbine of claim 1, the at least one hole in the liner being located at the predetermined axial location of the flow sleeve.

8. The gas turbine of claim 7, a portion of the airflow passing through the at least one hole in the liner and into the liner being hotter in temperature than a temperature of the airflow upstream of the predetermined axial location.

9. A gas turbine, comprising:
a combustor liner having at least one hole formed therein;
a flow sleeve that at least partially surrounds the liner thereby forming a plenum between the flow sleeve and the liner, the plenum having an airflow therethrough, a portion of the airflow passing through the at least one hole in the liner and into the liner thereby reducing the mass of the airflow in the plenum; and
a flow sleeve insert disposed next to an inner surface of the flow sleeve at a predetermined axial location of the flow sleeve, the flow sleeve insert having an axial profile that is reduced in cross section dimension at the predetermined axial location of the flow sleeve, thereby reducing a width of the plenum at the predetermined axial location, wherein the reduction at the cross section dimension in the flow sleeve insert increases a velocity of the airflow in the plenum at the predetermined axial location, thereby increasing transfer of heat away from the liner.

10. The gas turbine of claim 9, the flow sleeve insert being attached to an inner surface of the flow sleeve.

11. The gas turbine of claim 9, the flow sleeve insert being attached to an inner surface of the flow sleeve by one or more mounts.

12. The gas turbine of claim 11, the one or more mounts connected to the inner surface of the flow sleeve by welds.

13. The gas turbine of claim 11, the one or more mounts connected to an outer surface of the flow sleeve insert by welds, rivets, brazements, or bolts.

14. The gas turbine of claim 9, the liner comprising a liner for a diffusion combustor or a Dry Low Nitrous Oxides combustor.

15. The gas turbine of claim 9, the reduction at the cross section dimension at the predetermined axial location of the flow sleeve being with respect to a remaining portion of the flow sleeve.

16. A method for cooling a combustor liner, comprising:
providing a combustor liner with at least one hole formed therein; and
providing a flow sleeve that at least partially surrounds the liner thereby forming a plenum between the flow sleeve and the liner, the plenum having an airflow therethrough, a portion of the airflow passing through the at least one hole in the liner and into the liner thereby reducing the mass of the airflow in the plenum, the flow sleeve having an axial profile that is reduced in cross section dimension at a predetermined axial location of the flow sleeve, thereby reducing a width of the plenum at the predetermined axial location, wherein the reduction at the cross section dimension in the flow sleeve increases a velocity of the airflow in the plenum at the predetermined axial location, thereby increasing transfer of heat away from the liner.

17. The method of claim 16, wherein the liner is provided as part of a diffusion combustor.

18. The method of claim 16, wherein the liner is provided as part of a Dry Low Nitrous Oxides combustor.

19. The method of claim 16, wherein the predetermined axial location of the flow sleeve is provided at a relatively hot temperature location of the liner.

20. The method of claim 16, wherein the at least one hole in the liner being provided at the predetermined axial location of the flow sleeve, a portion of the airflow passing through the at least one hole in the liner and into the liner being hotter in temperature than a temperature of the airflow upstream of the predetermined axial location.
